(19) United States
(12) Patent Application Publication
(10) Pub. No.: US 2024/0218127 A1
(43) Pub. Date: Jul. 4, 2024

(54) CROWN ETHER-CONTAINING POLYMERS

(71) Applicant: Saudi Arabian Oil Company, Dhahran (SA)

(72) Inventors: Junyan Yang, Acton, MA (US); Sipei Li, Cambridge, MA (US)

(21) Appl. No.: 18/082,375

(22) Filed: Dec. 15, 2022

(51) Int. Cl. C08G 73/10; B01D 53/22; B01D 71/64; C08J 5/18; C10L 3/10

(52) U.S. Cl. CPC C08G 73/1082; B01D 53/228; B01D 71/643; C08J 5/18; C10L 3/103; C10L 3/104; C08J 2379/08; C10L 2290/548

(57) ABSTRACT

The present disclosure relates to crown ether-containing co-polyimides, and to membranes containing such. The present disclosure also relates to methods of using the membranes for gas separation applications.

### TECHNICAL FIELD

The present disclosure relates to crown ether-containing co-polyimides, and to membranes containing such. The present disclosure also relates to methods of using the membranes for gas separation applications.

### BACKGROUND

Natural gas supplies over 20% of the energy used worldwide and makes up nearly a quarter of electricity generation, and also plays a crucial role as a feedstock for industry. Raw natural gas is formed primarily of methane (CH₄); however, it also contains significant amounts of other components, such as acid gases (for example, CO₂ and H₂S). The bulk removal of these gases will not only bring about significant savings in operation costs and in capital investments in post-treatment units, but will also make these units more tolerable to significant deviations in treatment loads (feed gas quality and flow), which is a challenge for gas processing in the plants.

A widely applied technology used for the removal of acid gas from gas mixtures is amine absorption; however, there are drawbacks associated with this technology, as it is very energy-intensive, has high capital cost and heavy maintenance requirements.

Another technology that has gained greater industrial application is the use of polymeric membrane-based technology for gas separation applications such as natural gas sweetening, oxygen enrichment, hydrogen purification, and nitrogen and organic compounds removal from natural gas. Though this technology has high energy efficiency, a small footprint (ease of processability into different configurations), and low capital cost, there exists a trade-off behavior between productivity (permeability) and efficiency (selectivity). Industrial applications of such membranes are still limited for bulk removal of aggressive acid gases from natural gas (for example, simultaneous H₂S and CO₂ separation), due to low separation performance and high CO₂ plasticization.

Therefore, there is a need for high flux and gas-pair selective membranes for removing CO₂ and/or H₂S from natural gas that can be used under industrial conditions and actual field environments and testing conditions, such as a membrane that has a combination of high permeability and high selectivity. There is also a need for a membrane having a high resistance to plasticization. There is also a need for a method of removing acid gases from gas mixtures using membranes that have improved selectivity, as well as enhanced plasticization resistance.

### SUMMARY

Provided in the present disclosure is a polymer including:
a structural repeat unit of Formula I:

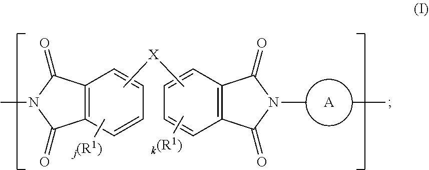

and
a structural repeat unit of Formula II:

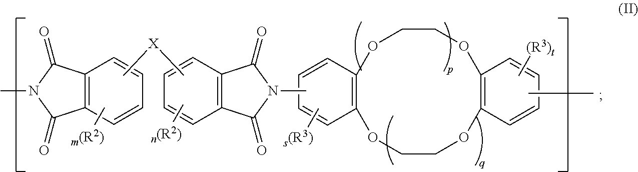

wherein:
A is
   phenylene, biphenylene, terphenylene, fluorene, spirobifluorene, an iptycene, or a polycyclic aromatic hydrocarbon, each optionally substituted with one or more R⁴; or
   a group of Formula III:

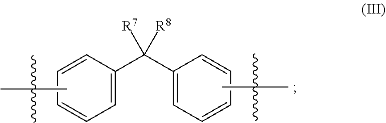

X and Y are each independently C₁₋₄ alkylene optionally substituted with one or more R⁵;
j, k, m, and n are each independently 0, 1, 2, or 3;
p and q are each independently 1, 2, 3, 4, or 5;
the sum of p and q is 2, 3, 4, 5, or 6;
s and t are each independently 0, 1, 2, or 3;
each R¹, R², and R³ is independently halo or C₁₋₄ alkyl optionally substituted with one or more halo;
each R⁴ and R⁵ is independently selected from halo, hydroxyl, amino, thiol, carboxyl, azido, and C₁₋₄ alkyl optionally substituted with one or more R⁶, wherein each R⁶ is independently selected from halo, hydroxyl, amino, thiol, carboxy, and azido; and
R⁷ and R⁸, together with the carbon to which they are attached, form a C₃₋₂₀ cycloalkyl or a 5- to 20-membered heterocyclyl each optionally substituted with one or more R⁴.

In some embodiments, A is phenylene, biphenylene, terphenylene, naphthalenylene, or anthracenylene, each optionally substituted with one, two, three, or four R⁴. In some embodiments, A is phenylene optionally substituted with one, two, three, or four R⁴. In some embodiments, each R⁴ is independently C₁₋₄ alkyl. In some embodiments, each R⁴ is independently unsubstituted C₁ alkyl.

In some embodiments, A is an iptycene optionally substituted with one, two, three, or four R⁴. In some embodiments, A is triptycene optionally substituted with one, two, three, or four R⁴.

In some embodiments, A is a group of Formula III. In some embodiments, R⁷ and R⁸, together with the carbon to which they are attached, form a phthalide or a fluorene.

In some embodiments, X and Y are each C₁ alkylene, optionally substituted with one or two R⁵. In some embodiments, each R⁵ is independently C₁ alkyl optionally substituted with one, two or three R⁶, and each R⁶ is independently halo. In some embodiments, j, k, m, and n are each independently 0 or 1.

In some embodiments, the sum of p and q is 2, 4, or 6. In some embodiments, p and q are each independently 1, 2, or 3. In some embodiments, p and q are each 1, p and q are each 2, or p and q are each 3.

In some embodiments, s and t are each independently 0 or 1.

In some embodiments, the structural repeat unit of Formula I is a structural repeat unit of Formula I-A:

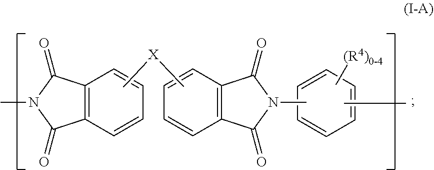

and
the structural repeat unit of Formula II is a structural repeat unit of Formula II-A:

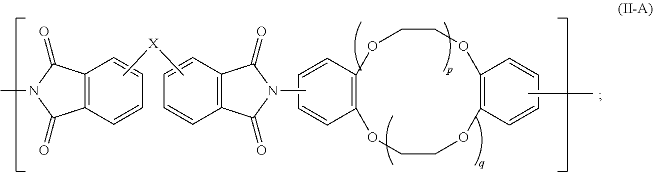

wherein
X and Y are the same;
each R⁴ and R⁵ is independently C₁₋₄ alkyl optionally substituted with one or more halo; and
the sum of p and q is 2, 4, or 6.

In some embodiments, X and Y are each C₁ alkylene substituted with one or two R⁵; each R⁴ is unsubstituted C₁ alkyl; and each R⁵ is independently C₁ alkyl optionally substituted with one, two, or three halo. In some embodiments, p and q are the same.

In some embodiments, the structural repeat unit of Formula I is a structural repeat unit of Formula I-B:

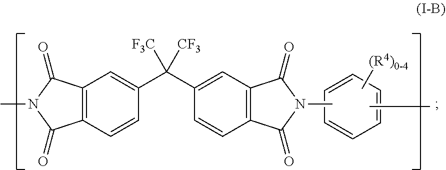

the structural repeat unit of Formula II is a structural repeat unit of Formula II-B:

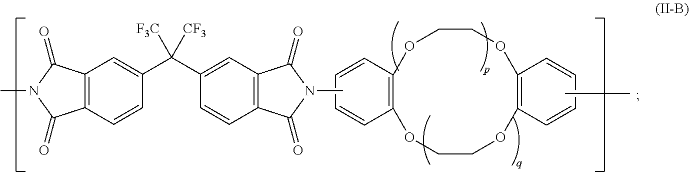

wherein
each R⁴ is independently unsubstituted C₁₋₄ alkyl; and
the sum of p and q is 2, 4, or 6.

In some embodiments, each R⁴ is unsubstituted C₁ alkyl. In some embodiments, p and q are the same.

In some embodiments, the polymer includes the structural repeat unit of Formula I and the structural repeat unit of Formula II in a molar ratio of about 5:1 to about 1:5. In some embodiments, the polymer includes the structural repeat unit of Formula I and the structural repeat unit of Formula II in a molar ratio of about 2:1 to about 1:2. In some embodiments, the polymer includes the structural repeat unit of Formula I and the structural repeat unit of Formula II in a molar ratio of about 1:1. In some embodiments, the polymer includes at least about 80 wt % of a total amount of the structural repeat unit of Formula I and the structural repeat unit of Formula II.

Also provided in the present disclosure is a membrane including a polymer of the present disclosure. In some embodiments, the membrane includes at least about 80 wt % of the polymer. In some embodiments, the membrane includes about 100 wt % of the polymer.

Also provided in the present disclosure is a method for separating CO₂ and H₂S from natural gas. The method includes introducing a natural gas stream to a membrane of the present disclosure; and separating the CO₂ and the H₂S from the natural gas stream.

In some embodiments, the natural gas stream includes about 1 vol % to about 30 vol % of CO₂; and about 1 vol % to about 40 wt % of H₂S before separating.

### BRIEF DESCRIPTION OF DRAWINGS

FIG. 1 is an ¹H NMR spectrum of dinitrilebenzo-18-crown-6 in DMSO-d₆.

FIG. 2 is an ¹H NMR spectrum of diaminobenzo-18-crown-6 in DMSO-d₆.

FIG. 3 is an ¹H NMR spectrum of 6FDA-(DAM:DAB18C6) (1:1) co-polyimide in DMSO-d₆.

FIG. 4 is an FTIR spectrum of 6FDA-(DAM:DAB18C6) (1:1) co-polyimide.

FIG. 5 is a DSC thermogram of a membrane including 6FDA-(DAM:DAB18C6) (1:1) co-polyimide.

FIG. 6 is a set of TGA curves for a membrane including 6FDA-(DAM:DAB18C6) (1:1) co-polyimide.

FIG. 7 is a schematic diagram of an exemplary constant-volume, variable pressure permeation apparatus used for measuring single gas and mixed gas permeation properties.

FIG. 8 is a plot of the membrane permeability-selectivity trade-off (CO₂/CH₄ vs. CO₂) for a membrane including 6FDA-(DAM:DAB18C6) (1:1) co-polyimide and for comparative polymer membranes in pure gas (25° C., 100 psi).

FIG. 9 is a plot of the membrane permeability-selectivity trade-off (CO₂/CH₄ vs. CO₂) for a membrane including 6FDA-(DAM:DAB18C6) (1:1) co-polyimide and for a comparative polymer membrane in a feed including 20 vol % CO₂ and 80 vol % CH₄ (25° C., 800 psi).

FIG. 10 is a plot of the membrane permeability-selectivity trade-off (CO₂/CH₄ vs. CO₂) for a membrane including 6FDA-(DAM:DAB18C6) (1:1) co-polyimide and for comparative polymer membranes in (solid shapes) a feed including 3 vol % CO₂, 5 vol % H₂S, and 92 vol % CH₄ and (open shapes) a feed including 10 vol % CO₂, 20 vol % H₂S, 10 vol % N₂, 3 vol % C₂H₆, and 57 vol % CH₄ (each 25° C., 800 psi).

FIG. 11 is a plot of the membrane permeability-selectivity trade-off (H₂S/CH₄ vs. H₂S) for a membrane including 6FDA-(DAM:DAB18C6) (1:1) co-polyimide and for comparative polymer membranes in (solid shapes) a feed including 3 vol % CO₂, 5 vol % H₂S, and 92 vol % CH₄ and (open shapes) a feed including 10 vol % CO₂, 20 vol % H₂S, 10 vol % N₂, 3 vol % C₂H₆, and 57 vol % CH₄ (each 25° C., 800 psi).

FIG. 12 is a graph of relative CO₂ permeability vs. CO₂ feed pressure for a membrane including 6FDA-(DAM:DAB18C6) (1:1) co-polyimide and for a comparative polymer membrane tested under CO₂ at 25° C.

### DETAILED DESCRIPTION

The present disclosure relates to co-polyimides including a non-coplanar di(amino benzo)-crown ether monomer unit and a rigid diamino monomer unit. Polymers of the present disclosure can have a distorted backbone structure, which can disrupt the polymer packing order in a membrane, improving the gas transport properties thereof. In some embodiments, membranes containing a polymer of the present disclosure have high selectivity for CO₂ separation from CH₄. In some embodiments, membranes containing a polymer of the present disclosure have high selectivity for H₂S separation from CH₄. In some embodiments, membranes containing a polymer of the present disclosure have high selectivity for CO₂ and H₂S separation from CH₄. In some embodiments, the membranes are resistant to plasticization. In some embodiments, the membranes have high selectivity for both CO₂ and H₂S, while at the same time remaining resistant to plasticization.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

The terms “a,” “an,” and “the” are used in the present disclosure to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used in the present disclosure, the term “about” can allow for a degree of variability in a value or range, for example, within 10%, within 5%, or within 1% of a stated value or of a stated limit of a range.

In the methods of the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used in the present disclosure, the term “monomer unit,” used in reference to a polymer, refers to a monomer, or residue of a monomer, that has been incorporated into at least a portion of the polymer.

As used in the present disclosure, the term “polymerization product,” used in reference to one or more monomers, refers to a polymer that can be formed by a chemical reaction of the one or more monomers. For example, a “polymerization product” of acrylic acid is a polymer containing acrylic acid monomer units.

As used in the present disclosure, the terms “crown ether macrocycle” and “crown ether” are interchangeable and refer to a cyclic polyether group containing at least 3 oxygen atoms, where each oxygen atom is separated from the other oxygen atoms by at least 2 carbon atoms.

As used in the present disclosure, the terms “crown ether macrocycle monomer units” and “crown ether monomer units” are interchangeable and refer to a monomer unit containing a crown ether group. Similarly, for example, the term “18-crown-6-ether monomer unit” refers to a monomer unit containing an 18-crown-6-ether group, while the term “24-crown-8-ether monomer unit” refers to a monomer unit containing a 24-crown-8-ether group.

As used in the present disclosure, the term “Cₙ₋ₘ alkyl” refers to any linear or branched saturated hydrocarbon group having n to m carbons. Alkyl groups include, but are not limited to, methyl, ethyl, propyl such as propan-1-yl, propan-2-yl (iso-propyl), butyl such as butan-1-yl, butan-2-yl (sec-butyl), 2-methyl-propan-1-yl (iso-butyl), 2-methyl-propan-2-yl (t-butyl), pentyl, hexyl, octyl, dectyl, and the like. As used in the present disclosure, the term “alkylene” refers to a bivalent alkyl.

As used in the present disclosure, the term “Cₙ₋ₘ cycloalkyl” refers to a single saturated or partially unsaturated all carbon ring having n to m annular carbon atoms. The term “cycloalkyl” also includes multiple condensed, saturated and partially unsaturated all carbon ring systems, including fused ring systems with one aromatic ring and one non-aromatic ring, but not fully aromatic ring systems. Accordingly, cycloalkyl includes multicyclic carbocycles such as a bicyclic carbocycles, and polycyclic carbocycles. Cycloalkyl groups include cyclopropyl, cyclobutyl, cyclopentyl, 1-cyclopent-1-enyl, 1-cyclopent-2-enyl, 1-cyclopent-3-enyl, cyclohexyl, 1-cyclohex-1-enyl, 1-cyclohex-2-enyl, spiro[3.3]heptane, and 1-cyclohex-3-enyl.

As used in the present disclosure, the terms “heterocyclyl” or “heterocycle” refer to a single saturated or partially unsaturated non-aromatic ring or a non-aromatic multiple ring system that has at least one heteroatom in the ring (at least one annular heteroatom selected from oxygen, nitrogen, and sulfur). In certain embodiments, a heterocyclyl group has from 5 to about 20 annular atoms. Thus, the term includes single saturated or partially unsaturated rings (for example, 3, 4, 5, 6 or 7-membered rings) having from about 1 to 6 annular carbon atoms and from about 1 to 3 annular heteroatoms selected from the group consisting of oxygen, nitrogen and sulfur in the ring. Heterocycles include, but are not limited to, groups derived from azetidine, aziridine, imidazolidine, morpholine, oxirane (epoxide), oxetane, piperazine, piperidine, pyrazolidine, piperidine, pyrrolidine, pyrrolidinone, tetrahydrofuran, tetrahydrothiophene, dihydropyridine, tetrahydropyridine, tetrahydro-2H-thiopyran 1,1-dioxide, quinuclidine, N-bromopyrrolidine, N-chloropiperidine, and the like. Heterocycles include spirocycles, such as, for example, aza or oxo-spiroheptanes. Heterocyclyl groups also include partially unsaturated ring systems containing one or more double bonds, including fused ring systems with one aromatic ring and one non-aromatic ring, but not fully aromatic ring systems. Examples include dihydroquinolines such as 3,4-dihydroquinoline, dihydroisoquinolines such as 1,2-dihydroisoquinoline, dihydroimidazole, tetrahydroimidazole, etc., indoline, isoindoline, isoindolones (such as isoindolin-1-one), isatin, dihydrophthalazine, quinolinone, spiro[cyclopropane-1,1′-isoindolin]-3′-one, and the like. Additional examples of heterocycles include 3,8-diazabicyclo[3.2.1]octanyl, 2,5-diazabicyclo[2.2.1]heptanyl, 3,6-diazabicyclo[3.1.1]heptanyl, 3-oxa-7,9-diazabicyclo[3.3.1]nonanyl, and hexahydropyrazino[2,1-c][1,4]oxazinyl.

As used in the present disclosure, the term “iptycene” refers to a compound including arene subunits bound to a bridged bicyclo-octatriene core structure. Examples of iptycenes include triptycene, pentiptycene, and the like.

As used in the present disclosure, the term “polycyclic aromatic hydrocarbon” refers to any multiple-condensed ring system of two or more fused, all-carbon aromatic rings. Polycyclic aromatic hydrocarbons include, but are not limited to, naphthalene, anthracene, triphenylene, pyrene, perylene, and the like.

As used in the present disclosure, the term “halo” refers to —F, —Cl, —Br, or —I.

As used in the present disclosure, the term “hydroxyl” refers to —OH.

As used in the present disclosure, the term “amino” refers to —NR^{N1}R^{N2}, where each of R^{N1} and R^{N2} is independently H or C₁₋₄ alkyl.

As used in the present disclosure, the term “thiol” refers to —SH.

As used in the present disclosure, the term “oxo” refers to ═O.

As used in the present disclosure, the term “carboxyl” refers to —C(O)OH.

As used in the present disclosure, the term “azido” refers to —N₃.

Where a variable of the present disclosure defines a group having more than one substituent (for example, group A of Formula (I)) and the Markush group definition for that variable lists, for example, a polycyclic aromatic hydrocarbon, then it is understood that the polycyclic aromatic hydrocarbon represents a substituent having the necessary valency.

### Polymers

Provided in the present disclosure are polymers that contain a structural repeat unit of Formula I:

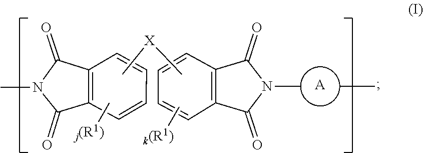

and
a structural repeat unit of Formula II:

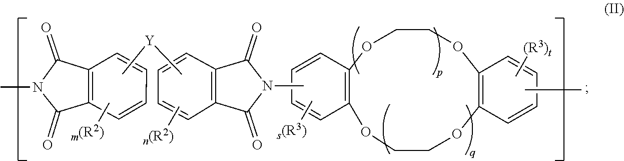

wherein:
   A is
      phenylene, biphenylene, terphenylene, or a polycyclic aromatic hydrocarbon, each optionally substituted with one or more R⁴; or
      a group of Formula III:

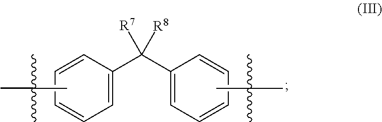

X and Y are each independently C₁₋₄ alkylene optionally substituted with one or more R⁵;
j, k, m, and n are each independently 0, 1, 2, or 3;
p and q are each independently 1, 2, 3, 4, or 5;
the sum of p and q is 2, 3, 4, 5, or 6;
s and t are each independently 0, 1, 2, or 3;
each R¹, R², and R³ is independently halo or C₁₋₄ alkyl optionally substituted with one or more halo;
each R⁴ and R⁵ is independently selected from halo, hydroxyl, amino, thiol, carboxyl, azido, and C₁₋₄ alkyl optionally substituted with one or more R⁶, wherein each R⁶ is independently selected from halo, hydroxyl, amino, thiol, carboxy, and azido; and
R⁷ and R⁸, together with the carbon to which they are attached, form a C₃₋₂₀ cycloalkyl or a 5- to 20-membered heterocyclyl each optionally substituted with one or more R⁴.

In some embodiments, X and Y are the same. In some embodiments, R¹ and R² are the same. In some embodiments, j and k are the same. In some embodiments, m and n are the same. In some embodiments, j, k, m, and n are the same. In some embodiments, s and t are the same.

In some embodiments, the structural repeat unit of Formula I and the structural repeat unit of Formula II make up at least about 80 wt % of the polymer. For example, in some embodiments, the structural repeat unit of Formula I and the structural repeat unit of Formula II make up at least about 85 wt %, at least about 90 wt %, at least about 95 wt %, at least about 97.5 wt %, at least about 98 wt %, at least about 98.5 wt %, or at least about 99 wt % of the polymer.

In some embodiments, the structural repeat unit of Formula I and the structural repeat unit of Formula II are present in the polymer in a molar ratio of about 5:1 to about 1:5. For example, in some embodiments, the structural repeat unit of Formula I and the structural repeat unit of Formula II are present in the polymer in a molar ratio of about 5:1 to about 1:3, about 5:1 to about 1:2, about 3:1 to about 1:5, about 3:1 to about 1:3, about 3:1 to about 1:2, about 2:1 to about 1:5, about 2:1 to about 1:3, or about 2:1 to about 1:2. In some embodiments, the structural repeat unit of Formula I and the structural repeat unit of Formula II are present in the polymer in a molar ratio of about 1:1.

The polymers of the present disclosure can be prepared according to any suitable method. For example, polymers including a structural repeat unit of Formula I and a structural repeat unit of Formula II can be prepared by polycondensation of a dianhydride monomer, a di(amino benzo)-crown ether monomer, and a rigid diamino monomer. In some embodiments, the polymer includes the polymerization product of a diphthalic anhydride monomer (for example, 4,4′-(hexafluoroisopropylidene)diphthalic anhydride), a di(amino benzo)-crown ether monomer (for example, di(amino benzo)-18-crown-6 monomer or di(amino benzo)-24-crown-8 monomer), and a rigid diamino monomer (for example, diamino trimethyl benzene).

### Formula I

In some embodiments, X is C₁ alkylene. In some embodiments, X is optionally substituted with one or two R⁵. For example, in some embodiments, X is substituted with one or two R⁵. In some embodiments of Formula I, one or more R⁵ are each independently C₁ alkyl optionally substituted with one, two, or three halo. In certain embodiments of Formula I, each R⁵ is independently C₁ alkyl optionally substituted with one, two, or three halo. In some embodiments of Formula I, each R⁵ is independently C₁ alkyl substituted with three halo. In certain such embodiments, one or more halo are —F. In certain such embodiments each halo is —F. In some embodiments, j and k are each independently 0 or 1. In some embodiments, j and k are each 0.

In some embodiments, A is phenylene, biphenylene, terphenylene, naphthalenylene, or anthracenylene. For example, in some embodiments, A is phenylene. In some embodiments, A is optionally substituted with one, two, three, or four R⁴. For example, in some embodiments, A is substituted with two or three R⁴. In some embodiments, A is phenylene substituted with three R⁴. In some embodiments, at least one R⁴ is independently C₁₋₄ alkyl. In some embodiments, each R⁴ independently C₁₋₄ alkyl. In certain such embodiments, each R⁴ is unsubstituted C₁₋₄ alkyl. For example, in some embodiments, each R⁴ is unsubstituted C₁ alkyl.

In some embodiments, A is fluorene or spirobifluorene, each optionally substituted with one, two, three, or four R⁴.

In some embodiments, A is an iptycene optionally substituted with one, two, three, or four R⁴. For example, in some embodiments, A is triptycene optionally substituted with one, two, three, or four R⁴.

In some embodiments, A is a group of Formula III. For example, in certain such embodiments, R⁷ and R⁸, together with the carbon to which they are attached, form a phthalide or a fluorene, each optionally substituted with one or two R⁴. For example, in some embodiments, A is:

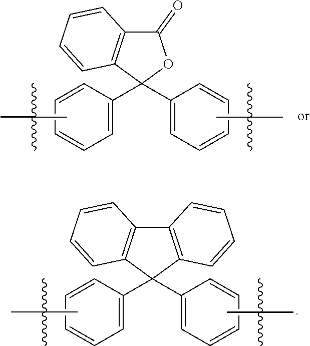

In some embodiments, the structural repeat unit of Formula I is a structural repeat unit of Formula I-A:

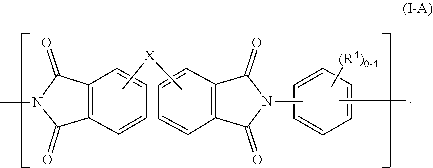

In certain embodiments of Formula I-A, X is the same as Y of Formula II or Formula II-A of the present disclosure. In some embodiments of Formula I-A, X is C₁ alkylene substituted with one or two R⁵. In some embodiments, Formula I-A includes two or three R⁴ groups. In some embodiments, each R⁴ and R⁵ of Formula I-A is independently C₁₋₄ alkyl optionally substituted with one or more halo. In certain embodiments of Formula I-A, each R⁴ is independently unsubstituted C₁₋₄ alkyl, and each R⁵ is independently C₁₋₄ alkyl substituted with three halo.

In some embodiments, the structural repeat unit of Formula I is a structural repeat unit of Formula I-B:

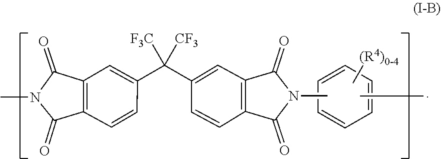

In some embodiments of Formula I-B, each R⁴ is independently unsubstituted C₁₋₄ alkyl. In certain such embodiments, each R⁴ is unsubstituted C₁ alkyl. In some embodiments, Formula I-B includes two or three R⁴ groups.

### Formula II

In some embodiments, Y is C₁ alkylene. In some embodiments, Y is optionally substituted with one or two R⁵. For example, in some embodiments, Y is substituted with one or two R⁵. In some embodiments of Formula II, one or more R⁵ are each independently C₁ alkyl optionally substituted with one, two, or three halo. In certain embodiments of Formula II, each R⁵ is independently C₁ alkyl optionally substituted with one, two, or three halo. In some embodiments of Formula II, each R⁵ is independently C₁ alkyl substituted with three halo. In certain such embodiments, one or more halo are —F. In certain such embodiments each halo is —F. In some embodiments, m and n are each independently 0 or 1. In some embodiments, m and n are each 0.

In some embodiments, p and q are each independently 1, 2, or 3. In some embodiments, p and q are each 1, or p and q are each 2, or p and q are each 3. In some embodiments, the sum of p and q is 6, 4, or 2. In some embodiments, s and t are each independently 0 or 1. In some embodiments, s and t are each 0.

In some embodiments, the structural repeat unit of Formula II is a structural repeat unit of Formula II-A:

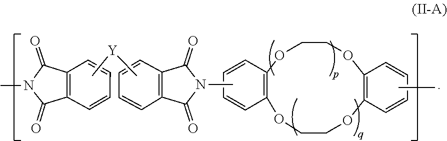

In certain embodiments of Formula II-A, Y is the same as X of Formula I or Formula I-A of the present disclosure. In some embodiments of Formula II-A, Y is C₁ alkylene substituted with one or two R⁵. In some embodiments, each R⁵ of Formula II-A is independently C₁₋₄ alkyl optionally substituted with one or more halo. In certain embodiments of Formula II-A, each R⁵ is independently C₁₋₄ alkyl substituted with three halo. In certain embodiments of Formula II-A, the sum of p and q is 2, 4, or 6. In certain embodiments of Formula II-A, p and q are the same.

In some embodiments, the structural repeat unit of Formula II is a structural repeat unit of Formula II-B:

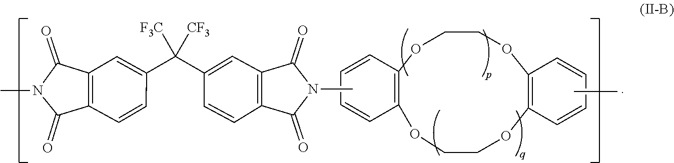

In certain embodiments of Formula II-B, the sum of p and q is 2, 4, or 6. In certain embodiments of Formula II-B, p and q are the same.

### Membranes

Also provided in the present disclosure are membranes including a polymer including a structural repeat unit of Formula I and a structural repeat unit of Formula II. In some embodiments, the membrane includes any polymer of the present disclosure.

In some embodiments, the membrane includes at least about 80 wt % of the polymer. For example, in some embodiments, the membrane includes at least about 85 wt %, at least about 90 wt %, at least about 95 wt %, at least about 97.5 wt %, at least about 98 wt %, at least about 98.5 wt %, or at least about 99 wt % of the polymer. In certain embodiments, the membrane includes about 100 wt % of the polymer.

### Methods for Preparing Membranes

Also provided in the present disclosure are methods for preparing a membrane of the present disclosure. Polymeric membranes are thin semipermeable barriers that selectively separate some gas compounds from others. The membranes are dense films that do not operate as a filter, but rather separate gas compounds based on how well the different compounds dissolve into the membrane and diffuse through it (the solution-diffusion model). In some embodiments, the membranes of the present disclosure are useful for any gas separation application, including, but not limited to, natural gas sweetening, oxygen enrichment, hydrogen purification, and nitrogen and organic compounds removal from natural gas. In some embodiments, the membranes of the present disclosure are used for the separation of CO₂ and H₂S from sour gas.

In some embodiments, the method includes preparing a solution of any polymer of the present disclosure. In some embodiments, the polymer is added to a solvent and dissolved. In some embodiments, the solvent is an organic solvent. In some embodiments, the solvent is o-dichlorobenzene, dichloromethane, or dimethyl sulfoxide. In some embodiments, the polymer is dissolved at room temperature. In some embodiments, the polymer is dissolved completely in the solvent before proceeding to the next step. In some embodiments, the polymer is filtered. In some embodiments, the polymer is filtered with a PTFE filter.

In some embodiments, the solution containing the polymer is poured into a flat-bottomed container in order to prepare a film. In some embodiments, the film is dried to allow for evaporation of solvent. In some embodiments, the film is dried at room temperature. In some embodiments, the film is dried for about 6 hours to about 1 day at room temperature. In some embodiments, the film is dried at an elevated temperature. In some embodiments, as the film is dried at an elevated temperature of about 50° C. to about 200° C., about 100° C. to about 200° C., or about 125° C. to about 175° C. for about 6 hours to about 1 day. In some embodiments, the film is further dried in a vacuum oven, for example, at about 100° C. to about 275° C., or about 150° C. to about 200° C. for at least about 12 hours, about 18 hours, about 24 hours, about 30 hours, about 36 hours, about 42 hours, about 48 hours, or more. In some embodiments, the film is dried in a vacuum oven at about 200° C. for about 24 hours.

In some embodiments, after drying, the film is soaked in a second solvent. In certain such embodiments, the second solvent is ethanol. In some embodiments, the film is soaked in the second solvent for at least about 12 hours, about 18 hours, about 24 hours, about 30 hours, about 36 hours, about 42 hours, about 48 hours, or more. In some embodiments, the second solvent is removed from the film, and then the film is dried to provide the membrane. In some embodiments, the second solvent is removed from the film, and then the film is dried in a vacuum oven, for example, at about 50° C. to about 200° C. for about 12 hours to about 48 hours.

Also provided in the present disclosure are membranes prepared by the methods of the present disclosure.

In some embodiments, the membranes of the present disclosure exhibit improved thermal stability. In some embodiments, the glass transition temperature of the membranes of the present disclosure is less than 350° C., for example, less than about 300° C., or less than about 275° C. In some embodiments, the temperature at 5% weight loss for the membranes of the present disclosure is at least about 300° C., for example, at least about 325° C., or at least about 350° C. In some embodiments, the temperature at 10% weight loss for the membranes of the present disclosure is at least about 375° C., for example, at least about 400° C., or at least about 425° C.

In some embodiments, the membranes of the present disclosure demonstrate improved gas transport properties in natural gas separation, for example, sour gas separation, as compared to conventional polymer-based membranes. In some embodiments, the membranes of the present disclosure demonstrate high CO₂/CH₄ selectivity, high H₂S/CH₄ selectivity, and resistance plasticization, for example, at a feed pressure up to about 800 psi and at a H₂S concentration of 5 vol % or more, as compared to conventional polyimide-based membranes.

In some embodiments, the membranes of the present disclosure show no CO₂ plasticization (no increase in CO₂ permeability) up to about 300 psi CO₂ pressure. In some embodiments, the CO₂ permeability of the membranes of the present disclosure increases by less than about 400%, less than about 375%, less than about 350%, less than about 325%, or less than about 300% under feed pressures up to about 500 psi as compared to feed pressure of about 50 psi. In some embodiments, the CO₂ permeability of the membranes of the present disclosure increases by less than about 450%, less than about 425%, less than about 400%, less than about 375%, or less than about 350% under feed pressures up to about 700 psi as compared to feed pressure of about 50 psi.

In some embodiments, the membranes of the present disclosure have a CO₂/CH₄ single gas selectivity (αCO₂/CH₄) of about 50 or more, for example about 50 to about 200, about 50 to about 150, or about 50 to about 125, when tested at feed temperature of 25° C. and feed pressure of 100 psi.

In some embodiments, the membranes of the present disclosure have a CO₂/CH₄ binary gas selectivity (αCO₂/CH₄) of about 40 or more, for example, about 40 to about 180, about 40 to about 140, or about 40 to about 100, when tested at a feed composition of 20 vol % CO₂ and 80 vol % CH₄, a feed temperature of 25° C., and a feed pressure of 800 psi.

In some embodiments, the membranes of the present disclosure of a CO₂/CH₄ mixed gas selectivity (αCO₂/CH₄) of about 40 or more, for example, about 40 to about 180, about 40 to about 140, or about 40 to about 100, when tested at a feed composition of 3 vol % CO₂, 5 vol % H₂S, and 92 vol % CH₄, at a feed temperature of 25° C., and at a feed pressure of 800 psi. In some embodiments, the membranes of the present disclosure of a H₂S/CH₄ mixed gas selectivity (αH₂S/CH₄) of about 27 or more, for example, about 27 to about 150, about 27 to about 100, or about 27 to about 80, when tested at a feed composition of 3 vol % CO₂, 5 vol % H₂S, and 92 vol % CH₄, at a feed temperature of 25° C., and at a feed pressure of 800 psi.

In some embodiments, the membranes of the present disclosure of a CO₂/CH₄ mixed gas selectivity (αCO₂/CH₄) of about 20 or more, for example, about 40 to about 150, about 20 to about 100, or about 20 to about 80, when tested at a feed composition of 10 vol % CO₂, 20 vol % H₂S, 10 vol % N₂, 3 vol % C₂H₆, and 57 vol % CH₄, at a feed temperature of 25° C., and at a feed pressure of 800 psi. In some embodiments, the membranes of the present disclosure of a H₂S/CH₄ mixed gas selectivity (αH₂S/CH₄) of about 37 or more, for example, about 37 to about 150, about 37 to about 100, or about 37 to about 90, when tested at a feed composition of 10 vol % CO₂, 20 vol % H₂S, 10 vol % N₂, 3 vol % C₂H₆, and 57 vol % CH₄, at a feed temperature of 25° C., and at a feed pressure of 800 psi.

### Methods of Using the Membranes

Also provided in the present disclosure are methods for using a membrane of the present disclosure. In some embodiments, the methods include separating CO₂, H₂S, or both from natural gas by introducing a natural gas stream to any membrane of the present disclosure, and separating the CO₂, H₂S, or both from the natural gas stream. In some embodiments, the natural gas stream includes about 1 vol % to about 30 vol % of CO₂ before separating. For example, in some embodiments, the natural gas stream includes about 1 vol % to about 20 vol %, about 1 vol % to about 15 vol %, about 3 vol % to about 30 vol %, about 3 vol % to about 20 vol %, or about 3 vol % to about 15 vol % of CO₂ before separating. In some embodiments, the natural gas stream includes about 1 vol % to about 40 vol % of H₂S before separating. For example, in some embodiments, the natural gas stream includes about 1 vol % to about 30 vol %, about 1 vol % to about 25 vol %, about 5 vol % to about 40 vol %, about 5 vol % to about 30 vol %, or about 5 vol % to about 25 vol % of H₂S before separating.

In some embodiments, the natural gas stream includes at least about 30 vol %, for example, at least about 40 vol %, or at least about 50 vol % of CH₄ before separating. In some embodiments, the natural gas stream further includes N₂, C₂H₆, or both.

### EXAMPLES

The invention is further described in the following examples, which do not limit the scope of the invention described in the claims.

### Example 1. 6FDA-(DAM:DAB18C6) (1:1) Membrane Preparation

### Synthesis of dinitrilebenzo-18-crown-6

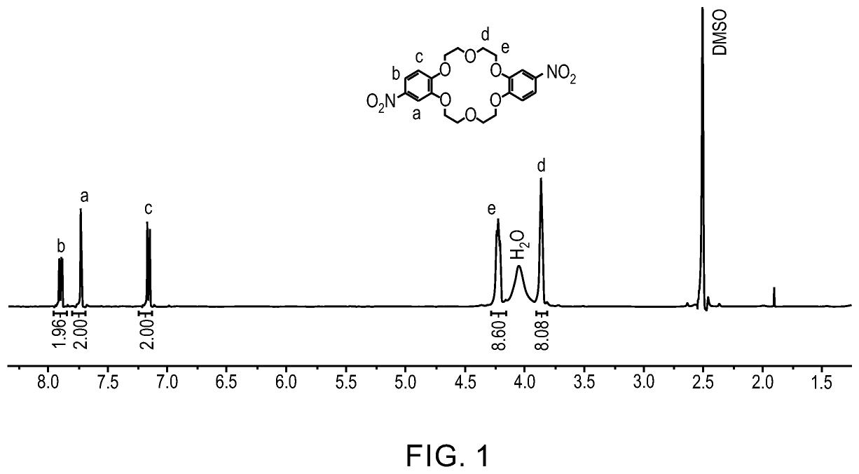

10.38 g of dibenzo-18-crown-6 was dissolved in 208 mL chloroform in a 500 mL round bottom flask equipped with a magnetic stirring bar. 156 mL acetic acid was added slowly over 10 min with stirring. 7.2 mL nitric acid together with 20.8 mL acetic acid were added slowly to the solution. The mixture was kept under nitrogen purge and stirring for 1 hour before heating to reflux for 3 hours. Precipitate evolved after 3 hours. The reaction mixture was cooled to room temperature. Precipitates were collected via vacuum filtration and dried at 70° C. for 24 hours to give 6.15 g white powder, characterized by ¹H NMR as shown in FIG. 1.

### Synthesis of diaminobenzo-18-crown-6 (DAB18C6)

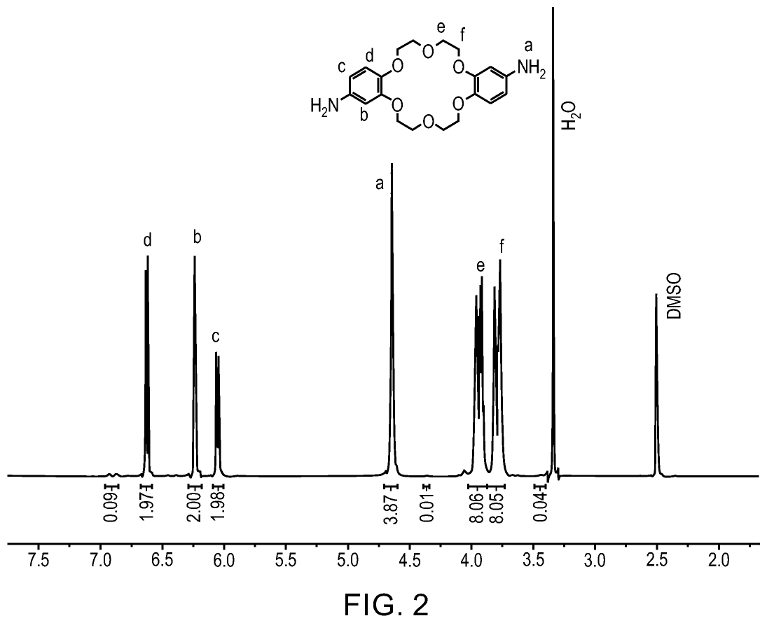

A 500 mL three-necked flask with stirring bar and an additional funnel were dried in an oven at 200° C. before use. 6.96 g dinitrobenzo-18-crown-6-ether and 696 mg Pd/C were added to 240 mL anhydrous ethanol in the 500 mL three-necked flask. 49 mL hydrazine hydrate was slowly added to the reaction mixture over 20 min. through an addition funnel, and then the mixture was heated to 90° C. for 5 hours. The reaction mixture was then immediately filtered under vacuum to avoid immediate crystallization. The solution was refrigerated to promote recrystallization, with dry solid crystals collected and dried at 80° C. to give 2.32 g product with purity >99% indicated by NMR, as shown in FIG. 2.

### Synthesis of 6FDA-(DAM:DAB18C6) (1:1) Co-Polyimide

(4,4′-hexafluoroisopropylidene) diphthalic anhydride (6FDA) from Akron Polymer Systems was used as received and dried at 160° C. under vacuum overnight before use. 2,4,6-trimethyl-1,3-diaminobenzene (DAM) from Akron Polymer Systems was used as received and dried at 70° C. under vacuum before use. Diaminobenzo-18-crown-6 (DAB18C6) was dried at 70° C. under vacuum before use. A 100 mL 3-necked flask, a glass stir rod and a dean-stark trap were dried at 200° C. overnight before use. 2.2757 g of 6FDA, 16 mL of ethanol, and 2 mL of trimethylamine were added to the flask, which was equipped with mechanical stirrer, nitrogen inlet, and dean-stark trap. The dean-stark trap was filled with ethanol. The reaction mixture was heated to reflux under nitrogen flow for 1 hour, followed by distillation of excess of triethylamine and ethanol to form a viscous ester-acid solution. Afterwards, 1 g of diaminobenzo-18-crown-6-ether and 0.3834 g DAM were added with 20 mL NMP and 5 mL o-dichlorobenzene (4/1 v/v). The dean-stark trap was drained and refilled with o-dichlorobenzene, and the reaction was heated gradually to 180° C. under N₂ flow. After 48 hours, a viscous solution was precipitated in 150 mL of methanol, and precipitates were collected and dried at 80° C. overnight to give 3.4 g of off-white 6FDA-(DAM:DAB18C6) (1:1) co-polyimide.

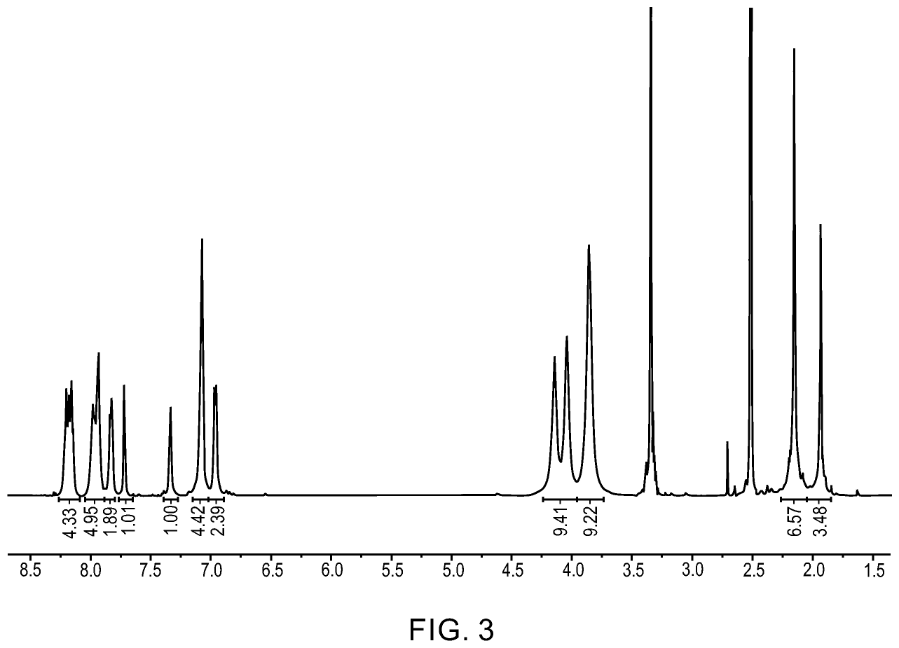

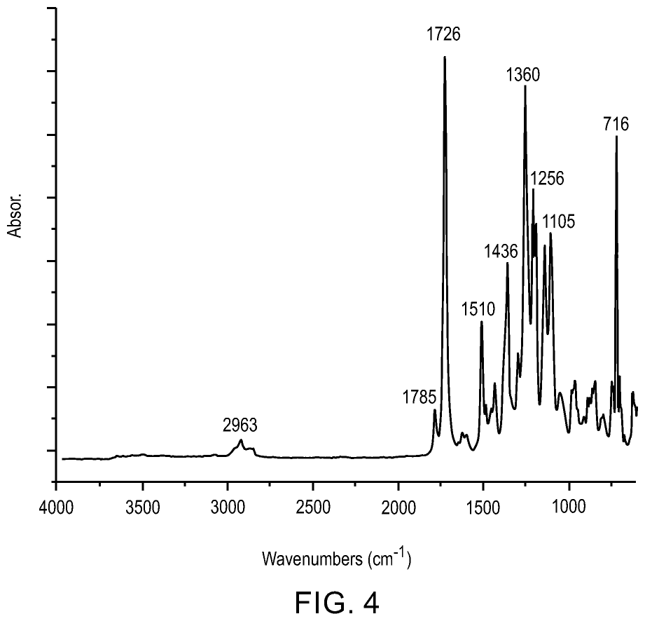

The product was characterized by NMR (FIG. 3) in DMSO-d6, which features the absence of amino peaks at ˜4.7 ppm, indicating no residual unreacted reactant. FIG. 3 show the ¹H NMR spectrum of 6FDA-(DAM:DAB18C6) co-polyimide. The spectrum shows the presence of the aromatic peaks of 6FDA and DAM at 8.2-7.8 ppm, DAM at 2.5-1.5 ppm (methyl groups), and DAB18C6 at 7.3-6.9 ppm (aromatic) and 4.5-3.75 ppm (ethylene). The product was also characterized by Fourier transform infrared spectroscopy (FTIR). The results, shown in FIG. 4, confirming complete imidization from the absence of any peaks containing amide groups in the wavenumber range of 3100 cm⁻¹ to 3500 cm⁻¹. The FTIR spectrum also shows the symmetric imide carbonyl stretching at ˜1720 cm⁻¹ and asymmetric imide carbonyl stretching at 1785 cm⁻¹.

### Membrane Fabrication

A 1.7-8 wt % dried polymer solution was prepared in dichloromethane (DCM) or dimethyl sulfoxide (DMSO) and filtered through a 0.5 μm filter. The solution was then cast on a clean glass plate or PTFE mold, and left to evaporate overnight at room temperature with a cover or on a hot plate at 150° C. if using DMSO as solvent. The film was then heated slowly in a vacuum oven to 200° C. for 24 hours to remove any residual solvent, and then cooled slowly to room temperature. The dried membrane was soaked in ethanol for 48 hours, and removed and pad dried, and then dried in a vacuum oven at 100° C. for 24 hours to yield Membrane 1.

### Example 2. 6FDA-(DAM:DAB24C8) (1:1) Membrane Preparation

### Synthesis of dinitrilebenzo-24-crown-8

5 g of dibenzo-24-crown-8 from Sigma Aldrich was dissolved in 80 mL chloroform in a 500 mL round bottom flask. 50 mL acetic acid was added slowly over 10 min. 2.787 mL nitric acid together with 18.4 mL acetic acid were slowly added to the flask over 20 min until the solution turned rose pink. The mixture was stirred at room temperature for 1 hour and then heated to reflux for three hours. After the reaction, the solution was extracted with 100 mL DI water three times to remove excess of acetic acid and impurities. The oil phase was collected and dried over MgSO₄. After filtration, the solution was dried under vacuum to give 5.45 g light yellow powder. The product was characterized with ¹H NMR.

¹H NMR (400 MHz, CDCl3) δ=7.89-7.86 (m, 2H), 7.72-7.71 (m, 2H), 6.86 (d, J=8.8 Hz 2H), 4.24-4.22 (m, 8H), 3.97-3.95 (m, 8H), 3.85-3.84 (m, 8H) ppm.

### Synthesis of diaminobenzo-24-crown-8 (DAB24C8)

A 500 mL round bottom flask with stirring bar, 50 mL addition funnel, condenser and glass stopper were dried in 200° C. oven overnight before use. 5 g dinitrobenzo-24-crown-8 and 418 mg Pd/C catalyst were added in 142 mL ethanol in a round bottom flask. 29.4 mL hydrazine hydrate was slowly added through addition funnel at nitrogen flow. The reaction was heated to reflux for 5 hours and filtered while still hot to avoid immediate recrystallization. The solution was refrigerated to promote recrystallization. Crystals were collected and dried under vacuum to give 2.45 g yellow powders characterized by ¹H NMR.

¹H NMR (400 MHz, DMSO-d6) δ=6.64 (d, J=8.4 Hz, 2H), 6.23 (d, J=2.4 Hz, 2H), 6.06-6.03 (m, 2H), 4.69 (s, 4H), 3.98-3.89 (m, 8H), 3.74-3.62 (m, 16H) ppm.

### Synthesis of 6FDA-(DAM:DAB24C8) (1:1) Co-Polyimide

(4,4′-hexafluoroisopropylidene) diphthalic anhydride (6FDA) from Akron Polymer Systems was used as received and dried at 160° C. under vacuum overnight before use. 2,4,6-trimethyl-1,3-diaminobenzene (DAM) from Akron Polymer Systems was used as received and dried at 70° C. under vacuum before use. Diaminobenzo-24-crown-8-ether (DAB24C8) was dried at 70° C. under vacuum before use. A 100 mL 3-necked flask, a glass stir rod and a dean-stark trap were dried at 200° C. overnight before use.

2.082 g of 6FDA, 16 mL of ethanol, and 2 mL of trimethylamine were added to the flask, which was equipped with mechanical stirrer, nitrogen inlet and dean-stark trap. The dean-stark trap was filled with ethanol. The reaction mixture was heated to reflux under nitrogen flow for 1 hour, followed by distillation of excess of triethylamine and ethanol to form viscous ester-acid solution. Afterwards, 1 g of diaminobenzo-24-crown-6 and 0.352 g DAM were added with 20 mL NMP and 5 mL o-dichlorobenzene (4/1 v/v). The dean-stark trap was drained and refilled with o-dichlorobenzene, and the reaction was heated gradually to 180° C. under N₂ flow. After 48 hours, viscous solution was precipitated in 150 mL of methanol, and precipitates were collected and dried at 80° C. overnight to give 2.4 g of off-white 6FDA-(DAM:DAB24C8) (1:1) co-polyimide. The product was characterized by NMR in DMSO-d6, which features the absence of amino peaks at ˜4.7 ppm, indicating no residual unreacted reactant.

### Membrane Fabrication

A 1.7-8 wt % dried polymer solution was prepared in dichloromethane (DCM) or dimethyl sulfoxide (DMSO) and filtered through a 0.5 μm filter. The solution was then cast on a clean glass plate or PTFE mold, and left to evaporate overnight at room temperature with a cover or on a hot plate at 150° C. if using DMSO as solvent. The film was then heated slowly in a vacuum oven to 200° C. for 24 hours to remove any residual solvent, and then cooled slowly to room temperature. The dried membrane was soaked in ethanol for 48 hours, and removed and pad dried, and then dried in a vacuum oven at 100° C. for 24 hours to yield Membrane 2.

### Example 3. Comparative Membrane Preparation

### Synthesis of 6FDA-(DAM:DABA) (3:2) Co-Polyimide

A comparative 6FDA-(DAM:DABA) (3:2) co-polyimide membrane was synthesized from (4,4′-hexafluoroisopropylidene) diphthalic anhydride (6FDA) (obtained from Akron Polymer Systems); 3,5-diaminobenzoic acid (DABA) (obtained from Akron Polymer Systems); and 2,4,6-trimethyl-1,3-diaminobenzene (DAM) (obtained from Akron Polymer Systems). All chemicals and solvents were used as received without further purification. 17.77 g 6FDA, 125 mL ethanol, and 10 mL triethylamine were added to a flask equipped with a mechanical stirrer, nitrogen inlet, and dean-stark trap. The dean-stark trap was filled with ethanol. The mixture was heated to reflux under nitrogen flow for 1 hour, followed by distillation of excess of triethylamine and ethanol to form a viscous ester-acid solution. Afterwards, 2.43 g DABA and 3.6 g DAM were added with 128 mL NMP and 32 mL o-dichlorobenzene (4/1 v/v). The dean-stark trap was drained and refilled with o-dichlorobenzene, and the reaction was heated gradually to 180° C. under N₂ flow. After 48 hours, the viscous solution was precipitated in 1500 mL of methanol, and precipitates were collected and dried at 80° C. overnight to give 20.8 g of off-white co-polyimide polymer. The product was characterized by NMR in DMSO-d₆, which features the absence of amino peaks at ˜4.7 ppm, indicating no residual unreacted reactant.

### Membrane Fabrication

The polymer was cast according to Examples 1 and 2 to provide comparative Membrane C1.

### Example 4. Comparative Membrane Preparation

### Synthesis of 6FDA-DAM Co-Polyimide

A comparative 6FDA-DAM co-polyimide membrane was synthesized from (4,4′-hexafluoroisopropylidene) diphthalic anhydride (6FDA) (obtained from Akron Polymer Systems) and 2,4,6-trimethyl-1,3-diaminobenzene (DAM) (obtained from Akron Polymer Systems). All the chemicals and solvents were used as received without further purification. 17.77 g 6FDA. 125 mL of ethanol, and 10 mL of trimethylamine were added to a flask equipped with a mechanical stirrer, nitrogen inlet and dean-stark trap. The dean-stark trap was filled with ethanol. The mixture was heated to reflux under nitrogen flow for 1 hour, followed by distillation of excess of triethylamine and ethanol to form a viscous ester-acid solution. Afterwards, 6.6 g DAM was added with 128 mL NMP and 32 mL o-dichlorobenzene (4/1 v/v). The dean-stark trap was drained and refilled with o-dichlorobenzene and the reaction was heated gradually to 180° C. under N₂ flow. After 48 hours, the viscous solution was precipitated in 1500 mL of methanol, and precipitates were collected and dried at 80° C. overnight to give 21.4 g of off-white co-polyimide polymer. The product was characterized by NMR in DMSO-d₆, which features the absence of amino peaks at ˜4.7 ppm, indicating no residual of unreacted reactant.

### Membrane Fabrication

The polymer was cast according to Examples 1 and 2 to provide comparative Membrane C2.

### Example 5. Membrane Thermal Properties

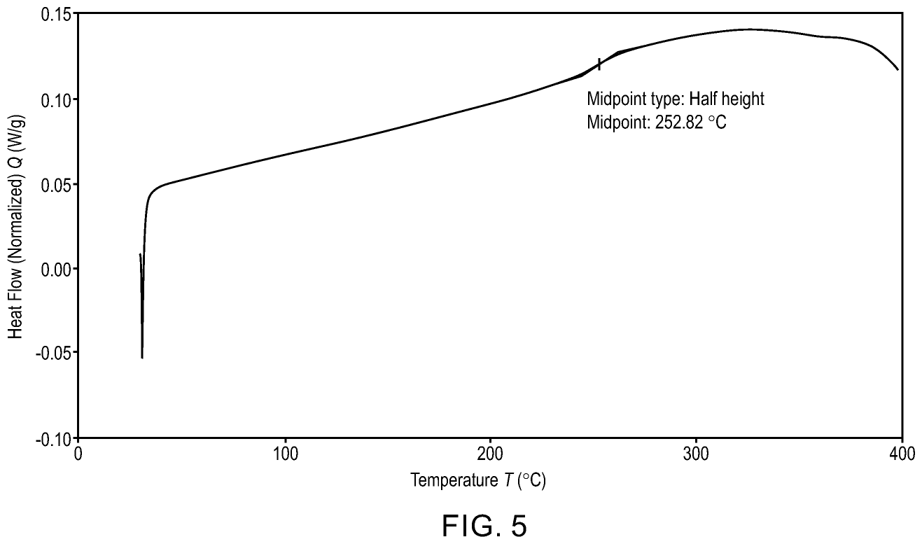

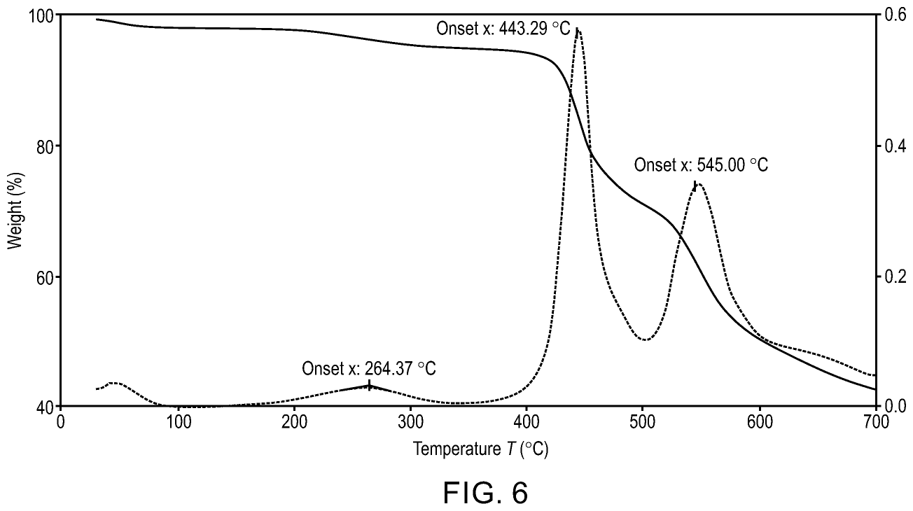

The thermal properties of Membrane 1, Membrane C1, and Membrane C2 were characterized via differential scanning calorimetry (Discovery DSC, 30 to 400° C. at a scanning rate of 10° C./min) and thermogravimetric analysis (Discovery TGA, 30 to 800° C. at a scanning rate of 10° C./min), and results are shown in Table 1, below. FIG. 5 is a DSC thermogram of Membrane 1, and FIG. 6 is a set of TGA curves for Membrane 1. Compared to Membrane C1 and Membrane C2, the Membrane 1 had a lower glass transition temperature (T_{g}=253° C.) and degradation temperature (T_{d}). As can be seen in FIG. 6, Membrane 1 was stable up to 250-300° C., which can be acceptable for gas-separation applications.

TABLE 1

| | T_{g} (° C.) | T_{d} @ 5 wt % (° C.) | T_{d} @ 10 wt % (° C.) |
|---|---|---|---|
| Membrane C2 | 395 | — | — |
| Membrane C1 | 375 | 410 | 511 |
| Membrane 1 | 253 | 356 | 434 |

### Example 6. Membrane Permeation Properties

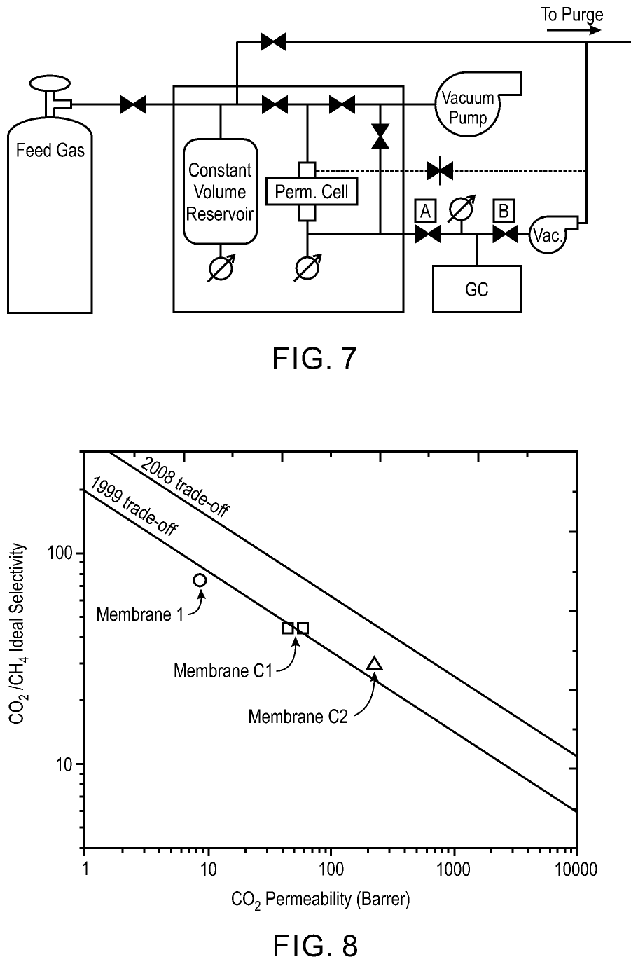

Gas permeation tests were performed in triplicate using a constant-volume, variable-pressure technique. A schematic diagram of this custom-built permeation apparatus is shown in FIG. 7.

A stainless-steel permeation cell with 47 mm disc filters was purchased from EMD Millipore. An epoxy masked membrane sample of 5-20 mm in diameter was inserted and sealed in the testing cell, and the permeation system was completely evacuated for 1 hour before each test. Pure gas permeability coefficients were measured at 25° C. and feed pressure range of 25 to 800 psi in the order of CH₄ followed by CO₂ to avoid swelling. Steady-state permeation was verified using the time-lag method, where 10 times the diffusion time-lag was taken as the effective steady-state. The upstream (feed) pressure and the downstream (permeate) pressure were measured using Baraton absolute capacitance transducers (MKS Instruments) and recorded using LabVIEW software. The permeate pressure was maintained below 100 torr.

Mixed gas permeation was performed at 25° C. and feed pressure range of 200 psi to 800 psi with binary gas mixture and sour gas mixtures. A retentate stream was added for mixed gas tests and adjusted to 100 times the permeate flow rate to maintain less than 1% stage cut. The permeate gas was collected and then injected into a Shimadzu gas chromatograph (GC-2014) to measure permeate composition. Permeate injections were performed at 95 torr. An Isco pump (TeledyneIsco) was used to control the feed pressure.

Permeability coefficients of gas i, Pᵢ, were calculated according to Equation 1, where dPᵢ/dₜ is the slope of the steady state pressure rise in the downstream, V is the downstream volume, R is the ideal gas constant, T is the temperature of the downstream, L is the membrane thickness (determined via JEOL 7100F scanning electron microscopy images of membrane cross sections), A is the membrane surface area (estimated using ImageJ image processing software), and Δfᵢ is the partial fugacity difference across the membrane calculated using the Peng-Robinson equation. Permselectivity, α_{i/j}, was calculated as the ratio of permeability coefficients as expressed in Equation 2.

$$\begin{matrix}{P}_{i} = \frac{{dP}_{i}}{{d}_{t}} \frac{V L}{R T A Δ {f}_{i}} & ( 1 ) \\ {α}_{i / j} = \frac{{P}_{i}}{{P}_{j}} & ( 2 )\end{matrix}$$

Pure gas permeation properties of Membrane 1, Membrane C1, and Membrane C2 are shown in FIG. 8. The results show that the CO₂/CH₄ gas separation performance goes along with the Robeson upper bound lines (1991 and 2008). The CO₂/CH₄ selectivity of Membrane 1 is located at the upper left quadrant, indicating significant enhanced separation performance. Table 2, below, shows the results of testing at 25° C. and feed pressure of 100 psi.

TABLE 2

| | P_{CO2} | P_{CH4} | |
|---|---|---|---|
| Membrane | (Barrer) | (Barrer) | αCO₂/CH₄ |
| C2 | 224.35 | 7.61 | 29.47 |
| C1 | 51.50 | 1.17 | 44.13 |
| 1 | 8.60 | 0.12 | 74.78 |

At 25° C. and a feed pressure of 100 psi, Membrane 1 exhibited a CO₂/CH₄ selectivity of 74.78, which is a 154% and 69% increase as compared to Membrane C2 and Membrane C1, respectively.

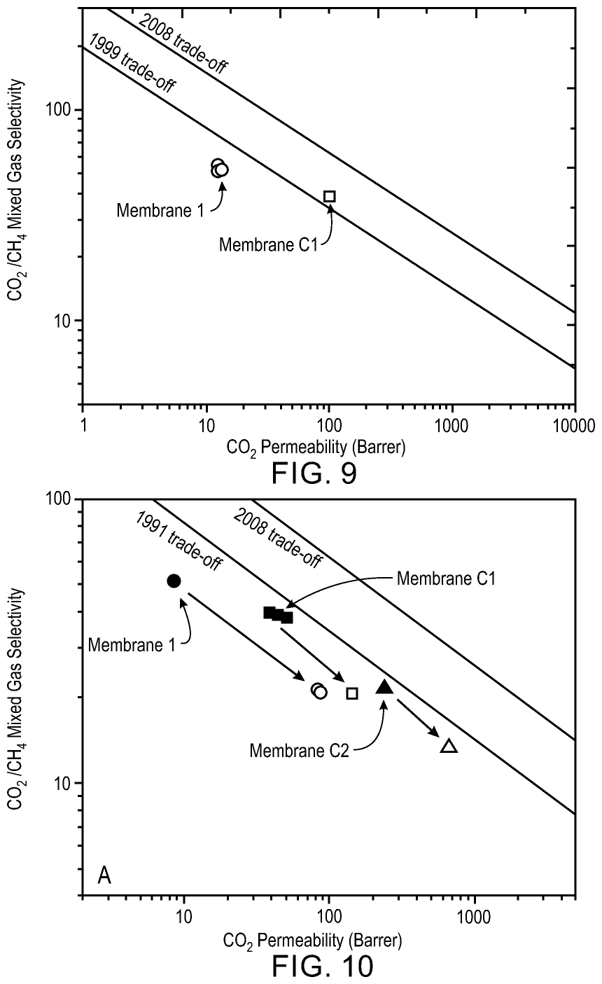

Binary gas mixture permeation properties of Membrane 1 and Membrane C1 are shown in FIG. 9. The results show that the CO₂/CH₄ gas separation performance goes along with the Robeson upper bound lines (1991 and 2008). The CO₂/CH₄ selectivity of Membrane 1 is located at the upper left quadrant, indicating significant enhanced separation performance. Table 2, below, shows the results of testing at a feed composition of 20 vol % CO₂ and 80 vol % CH₄, a feed temperature of 25° C., and a feed pressure of 800 psi.

TABLE 3

| | P_{CO2} | P_{CH4} | |
|---|---|---|---|
| Membrane | (Barrer) | (Barrer) | αCO₂/CH₄ |
| C1 | 101.27 | 2.64 | 38.29 |
| 1 | 13.06 | 0.25 | 52.25 |

At 25° C. and a feed pressure of 800 psi, Membrane 1 exhibited a CO₂/CH₄ selectivity of 52.25, which is a 36% increase as compared to Membrane C1.

Sour gas mixture permeation properties of Membrane 1, Membrane C1, and Membrane C2 are shown in FIGS. 10 and 11. The results show that Membrane 1 demonstrates simultaneous improvement in H₂S/CH₄ and CO₂/CH₄ sour gas separation at feed pressures up to 800 psi, with H₂S concentrations ranging from 5% to 20%

Table 4, below, shows the results of testing at a feed composition of 3 vol % CO₂, 5 vol % H₂S, and 92 vol % CH₄, a feed temperature of 25° C., and a feed pressure of 800 psi.

TABLE 4

| | P_{CO2} | P_{H2S} | | |
|---|---|---|---|---|
| Membrane | (Barrer) | (Barrer) | αCO₂/CH₄ | αH₂S/CH₄ |
| C2 | 237.59 | 288.03 | 21.46 | 26.01 |
| C1 | 44.19 | 29.31 | 38.88 | 25.79 |
| 1 | 8.65 | 5.55 | 51.53 | 33.07 |

At 25° C. and a feed pressure of 800 psi, Membrane 1 exhibited a CO₂/CH₄ selectivity of 51.53, which is a 140% and 33% increase as compared to Membrane C2 and Membrane C1, respectively, and an H₂S/CH₄ selectivity of 33.07, which is a 27% and 28% increase as compared to Membrane C2 and Membrane C1, respectively.

Table 5, below, shows the results of testing at a feed composition of 10 vol % CO₂, 20 vol % H₂S, 10 vol % N₂, 3 vol % C₂H₆, and 57 vol % CH₄, a feed temperature of 25° C., and a feed pressure of 800 psi.

TABLE 5

| | P_{CO2} | P_{H2S} | | |
|---|---|---|---|---|
| Membrane | (Barrer) | (Barrer) | αCO₂/CH₄ | αH₂S/CH₄ |
| C2 | 662.52 | 1648.34 | 13.30 | 33.09 |
| C1 | 143.32 | 244.76 | 20.66 | 35.29 |
| 1 | 83.96 | 179.60 | 20.96 | 44.72 |

At 25° C. and a feed pressure of 800 psi, Membrane 1 exhibited a CO₂/CH₄ selectivity of 20.96, which is a 58% and 1% increase as compared to Membrane C2 and Membrane C1, respectively, and an H₂S/CH₄ selectivity of 44.72, which is a 35% and 27% increase as compared to Membrane C2 and Membrane C1, respectively.

### Example 7. CO₂ Plasticization Resistance

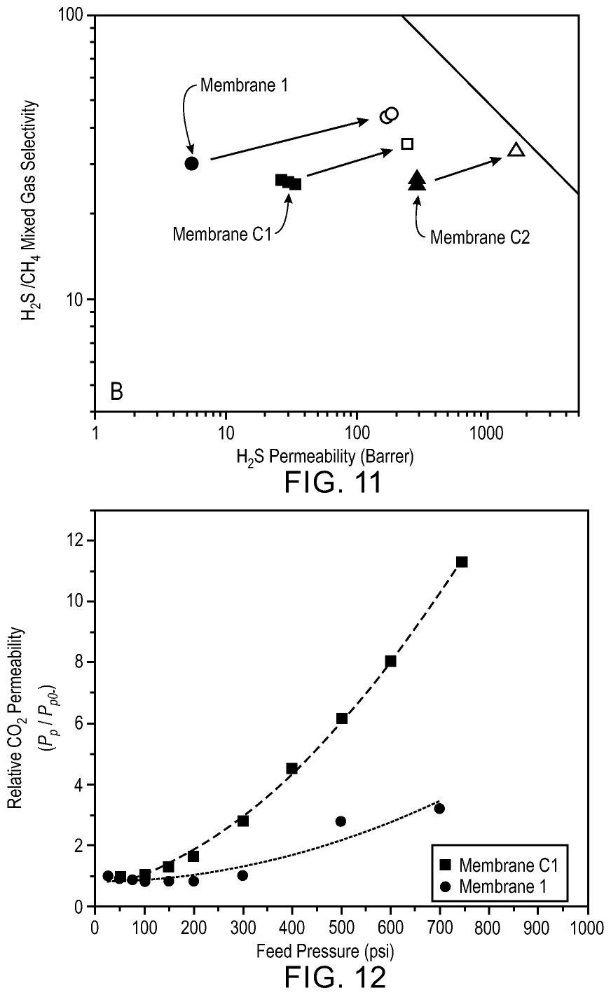

To study the plasticization resistance of Membrane 1, pure CO₂ permeation experiments were performed at increasing CO₂ feed pressure up to 700 psi. A substantial increase in the CO₂ permeability indicates plasticization. The change of CO₂ relative permeability (Pₚ/Pₚ₀) with the increase of the applied CO₂ pressure at 25° C. was calculated. As can be seen in FIG. 12, Membrane C1 exhibited a 281% and 616% increase in CO₂ permeability at 300 psi and 500 psi, respectively, compared to that at 50 psi. When the CO₂ applied feed pressure increased to 700 psi, Membrane C1 exhibited a 1130% increase in CO₂ permeability. The significant CO₂ permeability increase when applied CO₂ feed pressure was increased was due to the CO₂ plasticization (or swelling).

In contrast, no plasticization was observed for Membrane 1 up to 300 psi CO₂ feed pressure, and Membrane 1 showed only a 279% and 323% increase in CO₂ permeability at 500 psi and 700 psi, respectively, compared to that at 50 psi.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A polymer comprising:
a structural repeat unit of Formula I: 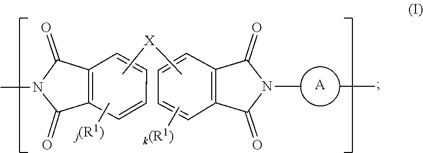
and
a structural repeat unit of Formula II: 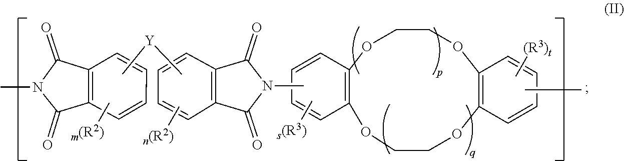
wherein:
A is
phenylene, biphenylene, terphenylene, fluorene, spirobifluorene, an iptycene, or a polycyclic aromatic hydrocarbon, each optionally substituted with one or more R⁴; or
a group of Formula III: 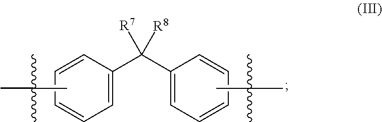
X and Y are each independently C₁₋₄ alkylene optionally substituted with one or more R⁵;
j, k, m, and n are each independently 0, 1, 2, or 3;
p and q are each independently 1, 2, 3, 4, or 5;
the sum of p and q is 2, 3, 4, 5, or 6;
s and t are each independently 0, 1, 2, or 3;
each R¹, R², and R³ is independently halo or C₁₋₄ alkyl optionally substituted with one or more halo;
each R⁴ and R⁵ is independently selected from halo, hydroxyl, amino, thiol, carboxyl, azido, and C₁₋₄ alkyl optionally substituted with one or more R⁶, wherein each R⁶ is independently selected from halo, hydroxyl, amino, thiol, carboxy, and azido; and
R⁷ and R⁸, together with the carbon to which they are attached, form a C₃₋₂₀ cycloalkyl or a 5- to 20-membered heterocyclyl each optionally substituted with one or more R⁴.

2. The polymer of claim 1, wherein A is phenylene, biphenylene, terphenylene, naphthalenylene, or anthracenylene, each optionally substituted with one, two, three, or four R⁴.

3. The polymer of claim 1, wherein A is phenylene optionally substituted with one, two, three, or four R⁴.

4. The polymer of claim 3, wherein each R⁴ is independently C₁₋₄ alkyl.

5. The polymer of claim 4, wherein each R⁴ is independently unsubstituted C₁ alkyl.

6. The polymer of claim 1, wherein A is an iptycene optionally substituted with one, two, three, or four R⁴.

7. The polymer of claim 6, wherein A is triptycene optionally substituted with one, two, three, or four R⁴.

8. The polymer of claim 1, wherein A is a group of Formula III.

9. The polymer of claim 8, wherein R⁷ and R⁸, together with the carbon to which they are attached, form a phthalide or a fluorene.

10. The polymer of claim 1, wherein X and Y are each C₁ alkylene, optionally substituted with one or two R⁵.

11. The polymer of claim 10, wherein each R⁵ is independently C₁ alkyl optionally substituted with one, two or three R⁶, and each R⁶ is independently halo.

12. The polymer of claim 1, wherein j, k, m, and n are each independently 0 or 1.

13. The polymer of claim 1, wherein the sum of p and q is 2, 4, or 6.

14. The polymer of claim 1, wherein p and q are each independently 1, 2, or 3.

15. The polymer of claim 1, wherein
p and q are each 1;
p and q are each 2; or
p and q are each 3.

16. The polymer of claim 1, wherein s and t are each independently 0 or 1.

17. The polymer of claim 1, wherein
the structural repeat unit of Formula I is a structural repeat unit of Formula I-A: 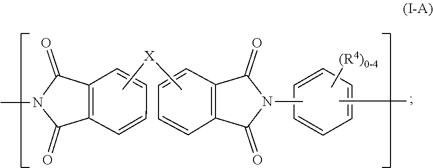
and
the structural repeat unit of Formula II is a structural repeat unit of Formula II-A: 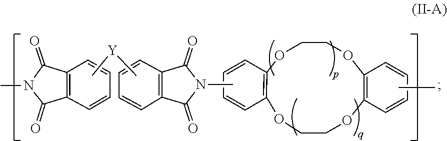
wherein
X and Y are the same;
each R⁴ and R⁵ is independently C₁₋₄ alkyl optionally substituted with one or more halo; and
the sum of p and q is 2, 4, or 6.

18. The polymer of claim 17, wherein
X and Y are each C₁ alkylene substituted with one or two R⁵;
each R⁴ is unsubstituted C₁ alkyl; and
each R⁵ is independently C₁ alkyl optionally substituted with one, two, or three halo.

19. The polymer of claim 17, wherein p and q are the same.

20. The polymer of claim 1, wherein
the structural repeat unit of Formula I is a structural repeat unit of Formula I-B: 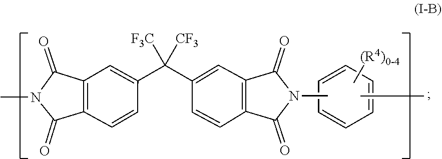
and
the structural repeat unit of Formula II is a structural repeat unit of Formula II-B: 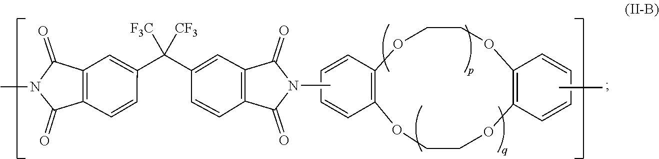
wherein
each R⁴ is independently unsubstituted C₁₋₄ alkyl; and
the sum of p and q is 2, 4, or 6.

21. The polymer of claim 20, wherein each R⁴ is unsubstituted C₁ alkyl.

22. The polymer of claim 20, wherein p and q are the same.

23. The polymer of claim 1, comprising the structural repeat unit of Formula I and the structural repeat unit of Formula II in a molar ratio of about 5:1 to about 1:5.

24. The polymer of claim 1, comprising the structural repeat unit of Formula I and the structural repeat unit of Formula II in a molar ratio of about 2:1 to about 1:2.

25. The polymer of claim 1, comprising the structural repeat unit of Formula I and the structural repeat unit of Formula II in a molar ratio of about 1:1.

26. The polymer of claim 1, comprising at least about 80 wt % of a total amount of the structural repeat unit of Formula I and the structural repeat unit of Formula II.

27. A membrane comprising the polymer of claim 1.

28. The membrane of claim 27, comprising at least about 80 wt % of the polymer.

29. The membrane of claim 27, comprising about 100 wt % of the polymer.

30. A method for separating CO₂ and H₂S from natural gas, the method comprising:
introducing a natural gas stream to the membrane of claim 25; and
separating the CO₂ and the H₂S from the natural gas stream.

31. The method of claim 30, wherein the natural gas stream comprises
about 1 vol % to about 30 vol % of CO₂; and
about 1 vol % to about 40 wt % of H₂S
before separating.
